(19) United States
(12) Patent Application Publication
(10) Pub. No.: US 2013/0129280 A1
(43) Pub. Date: May 23, 2013

(54) OPTICAL FIBER COUPLING CONNECTOR AND MALE PORT

(71) Applicant: I-THUN LIN, Tu-Cheng (TW)

(72) Inventor: I-THUN LIN, Tu-Cheng (TW)

(73) Assignee: HON HAI PRECISION INDUSTRY CO., LTD., Tu-Cheng (TW)

(21) Appl. No.: 13/473,799

(22) Filed: May 17, 2012

(30) Foreign Application Priority Data
Nov. 22, 2011 (TW) 100142643

(51) Int. Cl. G02B 6/32

(52) U.S. Cl. 385/33

(57) ABSTRACT

An optical fiber coupling connector includes a female port, a male port, a plurality of optical fibers, and a plurality of signal wires. The female port includes a first inserting portion and a second inserting portion. The second inserting portion includes a housing and a plurality of lenses fixed within the housing. The housing includes a receiving chamber. The plurality lenses separate the receiving chamber to a first inserting hole and a second inserting hole at opposite sides of the lenses. The first inserting portion is inserted into the first inserting hole, and the male port is inserted into the second inserting hole of and coupled with the female port. The optical fibers are inserted into the male port. The signal wires are inserted into the first inserting portion of the female port. The lenses couple the plurality of optical fibers and the signal wires.

### BACKGROUND

1. Technical Field

The present disclosure relates generally to coupling connectors, especially to an optical fiber coupling connector.

2. Description of Related Art

USB connectors are used for exchanging data between two electronic devices, such as an USB connector connecting a computer with a printer for exchanging the data of the files to be printed in the computer to the printer, for example.

The USB connectors of different types have different transmission speeds, such as the USB connector of USB 2.0 can transmit data in 480 Mbps, for example. The optical fiber coupling connector includes a female port and a male port, and either the female port or the male port may include a lens. In use, the male port is inserted into the female port, and the optical signals are transmitted between the female port and the male port via collimating by the lenses of the female port and the male port. When the optical fiber coupling connector is unused, the lens of male port is exposed in outer environment, thus the lens of the male port may be dirty, which results in a loss of the optical signal and a decrease of the transmitting efficiency.

In addition, the male port defines a plurality of blind holes for inserting optical fibers. The blind holes are aligned with the lens of the male port. Because the size of the blind holes is small, which results in the manufacturing of the blind holes being difficult. Furthermore, the position of blind holes may deviate and be unsuitable for the optical fibers to pass through, which results in a loss of the optical signals and a decrease of the transmitting efficiency of the optical fibers.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of one embodiment of an optical fiber coupling connector including a male port.

FIG. 2 is an exploded, isometric view of the optical fiber coupling connector shown in FIG. 1.

FIG. 3 is an exploded, isometric view of the male port of the optical fiber coupling connector shown in FIG. 1.

FIG. 4 is similar to FIG. 3, but viewed from another aspect.

FIG. 5 is a section view take along line V-V shown in FIG. 1.

### DETAILED DESCRIPTION

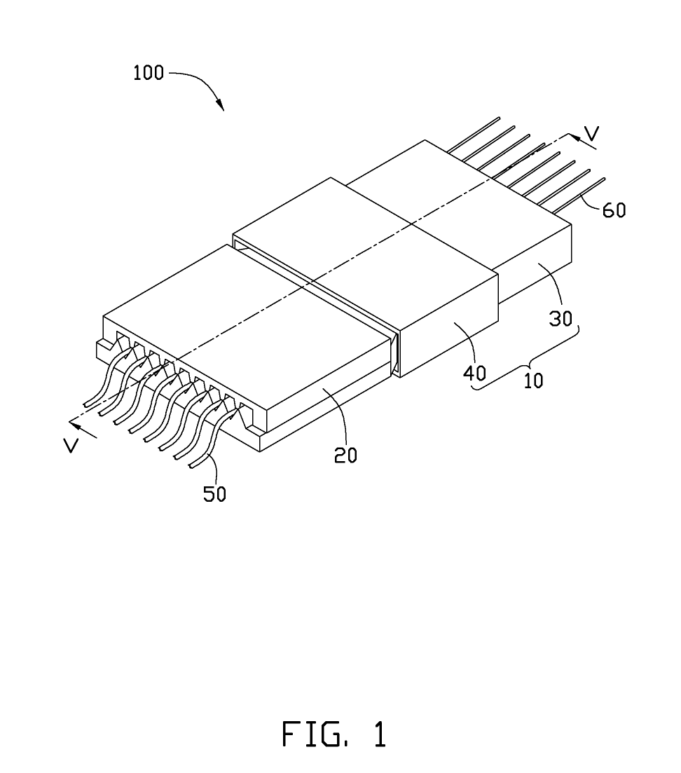

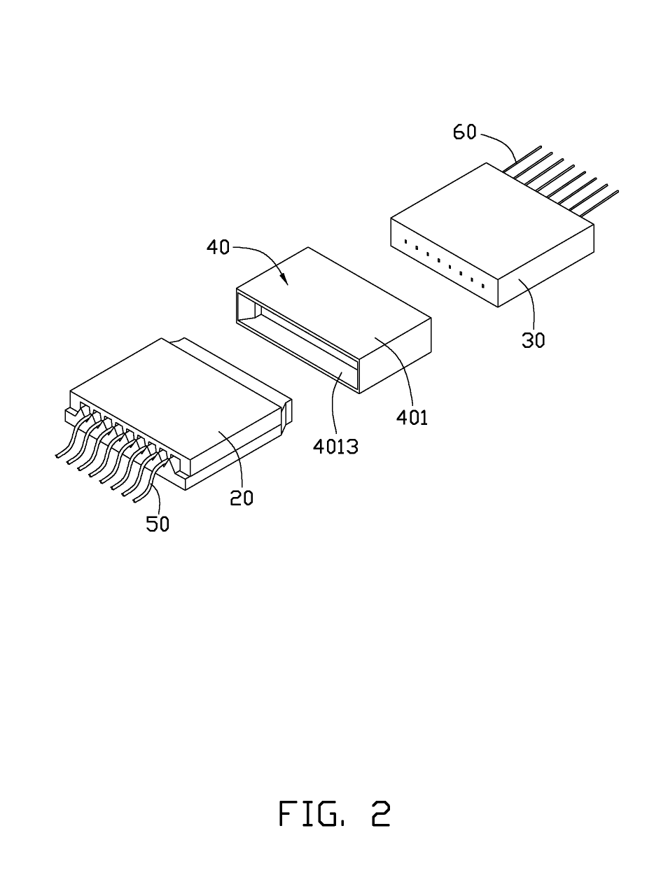

FIGS. 1 and 2, is one embodiment of an optical fiber coupling connector 100 including a female port 10, a male port 20 coupling with the female port 10, a plurality of optical fibers 50 inserted into the male port 20, and a plurality of signal wires 60 inserted into the female port 10. The female port 10 is mounted on an electronic device (not shown in FIG. 1). The electronic device may be a computer, a printer, a camera, for example. The male port 20 is portable, for coupling with the female port 10, thereby inputting data to the electronic device or outputting data from the electronic device.

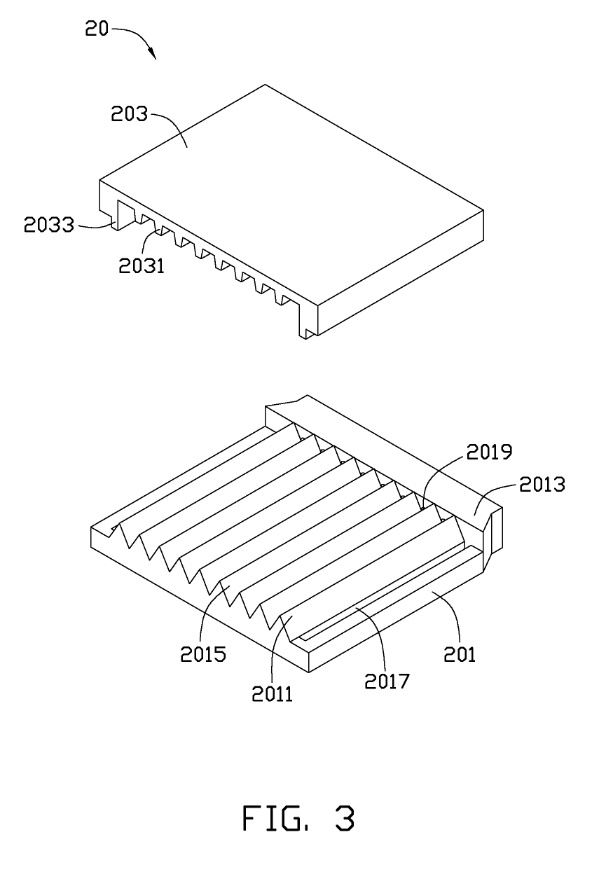

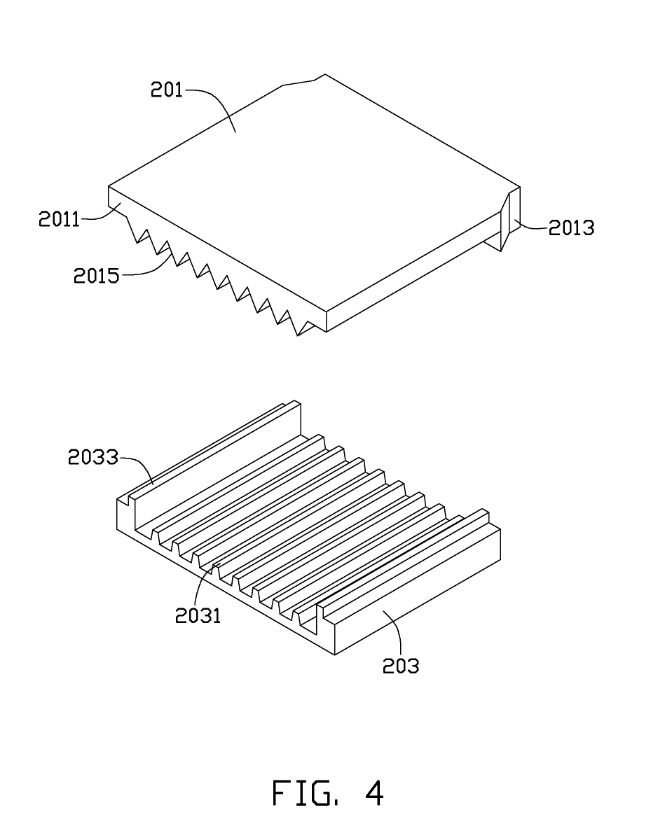

FIGS. 3 and 4, show the male port 20 including a main body 201 and a cover 203 detachably engaged with the main body 201. The optical fibers 50 are partially received and are fixed between the main body 201 and the cover 203.

The main body 201 is substantially a plate. The main body 201 includes a bearing portion 2011 joint with the cover 203, and a fastening portion 2013 mounted on an end of the bearing portion 2011. The bearing portion 2011 defines a plurality of V-shaped receiving grooves 2015 arranged side by side and spaced from each other, and a pair of positioning grooves 2017 defined in the opposite edges of the bearing portion 2011 at two sides of the receiving grooves 2015. An extending direction of each positioning groove 2017 is substantially perpendicular to the fastening portion 2013. The receiving grooves 2015 receive the corresponding optical fibers 50. The cover 203 engages with the positioning grooves 2017, thus enabling the main body 201 to detachably connect with the cover 203. In other embodiments, the receiving grooves 2015 can be designed as other shapes for stably receiving the optical fibers, such as trapeziform, for example.

The fastening portion 2013 is substantially cubic. A side of the fastening portion 2013 away from the bearing portion 2011 is narrower than another side adjacent to the bearing portion 2011. The fastening portion 2013 gradually narrows from the two sides to a middle portion thereof. The fastening portion 2013 defines a plurality of receiving holes 2019 at a sidewall of the fastening portion 2013 adjacent to the bearing portion 2011. Each receiving holes 2019 extends along the extending direction of the receiving grooves 2015 and communicates with a corresponding receiving groove 2015. The receiving holes 2019 are through holes, and each of the receiving holes is aligned with the corresponding receiving groove 2015. The receiving holes 2019 allow the optical fibers 50 to pass through, thereby enabling the optical fibers 50 to be positioned in the fastening portion 2013. In the illustrated embodiment, there are eight optical fibers 50, and the number of the receiving grooves 2015 and the receiving holes 2019 are eight accordingly. The eight optical fibers 50 include four inputting optical fibers 50 and four outputting optical fibers 50. The inputting optical fibers 50 transmit optical signals from the electronic device to another electronic device (not shown), such as a camera for example, and the outputting optical fibers 50 transmit optical signals from the camera to the electronic device.

The cover 203 is substantially a plate, and mounted on the bearing portion 2011 of the main body 201. The cover 203 protrudes a plurality of resisting bars 2031 arranged apart, and a pair of positioning portions 2033 at opposite sides of the resisting bars 2031 at the surface adjacent to the bearing portion 2011. The resisting bars 2031 are substantially trapezoids in accordance with the receiving grooves 2015 of the bearing portion 2011. The resisting bars 2031 resist the optical fibers 50 received in the receiving groove 2015. The positioning portions 2033 are inserted into the positioning grooves 2017, for positioning the cover 203 to the main body 201. In the illustrated embodiment, there are eight resisting bars 2031 according to the receiving grooves 2015. In other embodiments, the resisting bars 2031 may protrude from the bearing portion 2011 of the main body 201, and the receiving grooves 2017 may be defined in the cover 203.

Referring to FIGS. 1 and 2 again, the female port 10 includes a first inserting portion 30, and a second inserting portion 40 inserted into the first inserting portion 30 from a distal end. The second inserting portion 40 is mounted on the electronic device. In other embodiments, the second inserting portion 40 can be integrated with the electronic device.

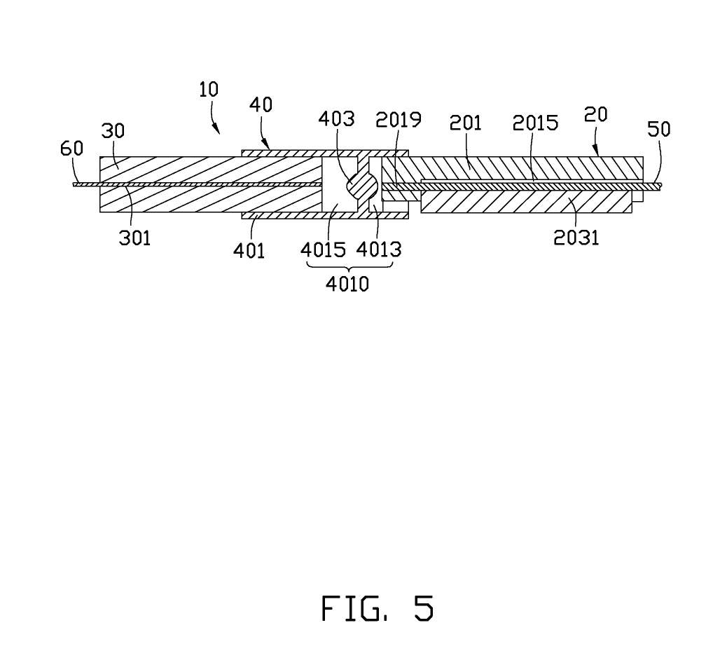

FIG. 5, shows the first inserting portion 30 defines a plurality of through holes 301 on the sidewall thereof adjacent to the second inserting portion 30, for receiving signal wires 60. In the illustrated embodiment, there are eight signal wires 60, and the number of the through holes 301 is eight accordingly. The eight signal wires 60 include four inputting signal wires and four outputting signal wires. The inputting signal wires input signals to the electronic device from another electronic device, and the outputting signal wires output signals from the electronic device to another electronic device. The four signal inputting signal wires 60 are aligned with the four outputting optical fibers 50, and the four signal outputting signal wires 60 are aligned with the four inputting optical fibers 50. In other embodiments, a signal receiver (not shown) may be set at an end of the inputting signal wires 60 adjacent to the optical fibers 50, for receiving the signals transmitted by the optical fibers 50, and a laser diode may be set at an end of the outputting signal wires 60 adjacent to the optical fibers 50, for emitting signals to the optical fibers 50.

The second inserting portion 40 includes a housing 401 and a plurality of lenses 403. The housing 401 is substantially a hollow cubic, and defines a receiving chamber 4010. The lenses 403 are vertically fastened within the housing 401, and the lenses 403 separate the receiving chamber 4010 into a first inserting hole 4013 away from a center portion of the first inserting portion 40 and s second inserting hole adjacent to the center portion of the first inserting portion 40. The first inserting hole 4013 receives the male port 20, and the second inserting hole 4015 receives the first inserting portion 30. The lenses 403 couple the optical fibers 50 and the signal wires 60, and collimate the optical signal between the optical fibers 50 and the signal wires 60, for improving the throughput of the optical fibers 50 and the signal wires 60. The first inserting hole 4013 gradually narrows from two opposite sides to a middle portion thereof, to match with a profile of the fastening portion 2013, for allowing the fastening portion 2013 to be inserted into and positioned in the second inserting portion 40. In the illustrated embodiment, there are eight lenses 403, and each of the lenses 403 is aligned with one optical fiber 50. The lenses 403 are biconvex aspheric condensing lenses. In the illustrated embodiment, the inner surface of housing 401 is coated with a high reflection coating.

In assembly of the female port 10, the signal wires 60 are inserted into the through hole 301 of the first inserting portion 30, and the first inserting portion 30 bearing with the signal wires 60 is inserted into the second inserting hole 4015 of the second inserting portion 40.

In assembly of the optical fiber coupling connector 100, the optical fibers 50 are inserted into the receiving holes 2019 of the male port 20, and the optical fibers 50 are received in the receiving grooves 2015. The positioning portions 2033 are inserted into the positioning grooves 2017, and the resisting bars 2031 resist the optical fibers 50, thus the optical fibers 50 are fastened within the male port 20. The male port 20 bearing the optical fibers 50 is inserted into the first inserting hole 4013 of the female port 10.

In use, optical signals are emitted from the optical fiber 50 to the signal wires 60 via the lenses 403 and the signal receiver, and then the signal wires 60 transmit the optical signals to an electronic device connected to the female port 10. The optical signals from the electronic device are emitted by the signal wires 60 to the optical fibers 50 via collimating by the lenses 403.

Because the lenses 403 are located within the receiving chamber 4010 of the second inserting portion 40, thus the lenses 403 remain clean because they are separated from an outer environment by the second inserting portion 40. Because the male port 20 consists of the main body 201 and the cover 203 detachably mounted together, thus the blind holes of the prior art can be omitted to achieve a simple way for manufacturing the male port 20. In addition, the resisting bars 2031 are received in the receiving grooves 2015, thus the optical fibers 50 received at the bottom of the receiving grooves 2015 are tightly fixed by the resisting bars 2031. The biconvex aspheric condensing lenses 403 replace the two lenses that need coupling together of the prior art, thus the cost of optical fiber coupling connector 100 is reduced.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An optical fiber coupling connector, comprising:
a female port comprising a first inserting portion and a second inserting portion, the second inserting portion comprising a housing and a plurality of lenses fixed within the housing, the housing comprising a receiving chamber, the plurality lenses separating the receiving chamber into a first inserting hole and a second inserting hole at opposite sides of the lenses, the first inserting portion inserted into the first inserting hole of the second inserting portion;
a male port inserted into the second inserting hole of the second inserting portion and coupled with the female port;
a plurality of optical fibers inserted into the male port; and
a plurality of signal wires inserted into the first inserting portion of the female port, wherein the plurality of lenses couple corresponding optical fibers and corresponding signal wires.

2. The optical fiber coupling connector of claim 1, wherein the plurality of lenses are biconvex aspheric condensing lenses.

3. The optical fiber coupling connector of claim 1, wherein an inner surface of housing is coated with a high reflection coating.

4. The optical fiber coupling connector of claim 1, wherein the first inserting portion defines a plurality of through holes at a sidewall adjacent to the second inserting portion; the plurality of through holes are aligned with corresponding lenses.

5. The optical fiber coupling connector of claim 4, wherein the male port comprises a main body and a cover detachably mounted on the main body; the optical fibers are fixed between the main body and the cover; the optical fibers are aligned with the plurality of lenses of the second inserting portion.

6. The optical fiber coupling connector of claim 5, wherein the main body comprises a bearing portion joint with the cover, and a fastening portion formed at an end of the bearing portion; the bearing portion defines a plurality of receiving grooves arranged side by side and spaced from each other; an extending direction of each receiving groove is substantially perpendicular to the fastening portion; the fastening portion defines a plurality of receiving holes at a sidewall adjacent to the bearing portion; the receiving grooves are aligned with the receiving holes, the optical fibers are received in the plurality of receiving grooves; the cover forms a plurality of resisting bars arranged apart and side by side; the plurality of resisting bars are received in the receiving grooves, and the plurality of resisting bars resist the optical fibers.

7. The optical fiber coupling connector of claim 6, wherein the plurality of receiving grooves are V-shaped grooves.

8. The optical fiber coupling connector of claim 6, wherein the bearing portion further defines a pair of positioning grooves in opposite edges thereof; and the positioning grooves are located at opposite sides of the plurality of receiving grooves; the cover forms a pair of positioning portion at a side towards the main body; the positioning portions are located at an opposite side of the plurality of resisting bars; the positioning portions are received in the positioning grooves, for positioning the cover to the main body.

9. The optical fiber coupling connector of claim 6, wherein a side of the fastening portion away from the bearing portion is narrower than another side adjacent to the bearing portion, and the fastening portion gradually narrows from the two sides to a middle portion thereof, the first inserting hole gradually narrows from two opposite sides to a middle portion thereof to match with a profile of the fastening portion, for allowing the fastening portion to insert into and positioned in the second inserting portion.

10. The optical fiber coupling connector of claim 6, wherein the plurality of optical fibers comprises inputting optical fibers and outputting optical fibers; the plurality of signal wires comprises inputting signal wires and outputting signal wires; the inputting optical fibers are aligned with the outputting signal wires, the outputting optical fibers are aligned with the inputting signal wires.

11. A male port of an optical fiber coupling connector, comprising:
a main body comprising a bearing portion and a fastening portion formed at an end of the bearing portion; and
a cover detachably mounted on the main body;
wherein the bearing portion defines a plurality of receiving grooves arranged apart and side by side; an extending direction of each receiving groove is substantially perpendicular to the fastening portion; the fastening portion defines a plurality of receiving holes arranged apart, and the receiving grooves are aligned with the receiving holes; the cover forms a plurality of resisting bars arranged apart and side by side; the plurality of resisting bars are received in the receiving grooves.

12. The male port of an optical fiber coupling connector of claim 11, wherein the plurality of receiving grooves are V-shaped grooves.

13. The male port of an optical fiber coupling connector of claim 11, wherein the bearing portion further defines a pair of positioning grooves in opposite edges; the positioning grooves are located at opposite side of the plurality of receiving grooves; the cover forms a pair of positioning portion at a side towards the main body; the positioning portions are located at an opposite side of the plurality of resisting bars; the positioning portions are received in the positioning grooves, for positioning the cover to the main body.

14. The male port of an optical fiber coupling connector of claim 11, wherein a side of the fastening portion away from the bearing portion is narrower than another side adjacent to the bearing portion, and the fastening portion gradually narrows from the two sides to a middle portion.
